(19) United States
(12) Patent Application Publication
(10) Pub. No.: US 2025/0206230 A1
(43) Pub. Date: Jun. 26, 2025

(54) PROVIDING A TRANSPARENT VIEW OF AN EXTERNAL ENVIRONMENT FROM INSIDE A VEHICLE

(71) Applicant: Volvo Car Corporation, Göteborg (SE)

(72) Inventors: Torbjorn Larsson, Göteborg (SE); Jonas Forssell, Göteborg (SE); Joachim Härsjö, Göteborg (SE)

(21) Appl. No.: 18/391,937

(22) Filed: Dec. 21, 2023

(51) Int. Cl. B60R 1/23

(52) U.S. Cl. CPC B60R 1/23; B60R 2300/10; B60R 2300/202; B60R 2300/802

(57) ABSTRACT

A system for providing a transparent view of an external environment from inside a vehicle. The system includes at least one portion of the vehicle that is a visual obstruction of a portion of an external environment from a perspective of an interior position in the vehicle. The system further includes at least one perception sensor, wherein the at least one perception sensor captures images of the external environment. The system further includes at least one display positioned inside the vehicle, wherein the display presents a transparent view that represents the portion of the external environment that is obstructed from the perspective of the interior position in the vehicle.

### INTRODUCTION

The present disclosure relates generally to the automotive field. A common challenge to drivers of vehicles is poor visibility such as blind spots caused by the body of a vehicle. For example, when a driver is making a turn or backing up, etc., it can be difficult for the driver to see the surrounding environment due to pillars between windows that obstruct the view of the driver. Such visual obstructions or blind spots may vary in size and quantity from vehicle to vehicle. Any and all visual obstructions increase the risk of the driver not seeing any potential hazardous objects or people that the vehicle could hit.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for providing a seamless view or seemingly transparent view of an external environment from inside a vehicle. As described in more detail herein, one or more perception sensors capture an exterior view including areas visually obstructed from inside the vehicle. One or more displays inside the vehicle display obstructed portions of the exterior view to create a seamless view of the exterior. Such displays may be positioned at the dashboard and/or at one or more of portions of the vehicle that are visually obstructing the exterior view.

In one illustrative embodiment, the present disclosure provides an assembly for a vehicle. The assembly includes: at least one portion of the vehicle that is a visual obstruction of a portion of an external environment from a perspective of an interior position in the vehicle; at least one perception sensor, wherein the at least one perception sensor captures images of the external environment; and at least one display positioned inside the vehicle, wherein the display presents a transparent view that represents the portion of the external environment that is obstructed from the perspective of an interior position in the vehicle. Optionally, the at least one portion of the vehicle is one or more of an A-pillar, a B-pillar, a C-pillar, and a D-pillar of the vehicle. In some embodiments, the at least one portion of the vehicle is a roof of the vehicle. In some embodiments, the perspective of the interior position in the vehicle is a perspective of a driver's seat. In some embodiments, the at least one perception sensor has a field of view that is greater than the transparent view that is presented in the at least one display. In some embodiments, the at least one display is positioned at a dashboard of the vehicle. In some embodiments, the at least one display is positioned at the least one portion of the vehicle that is the visual obstruction of the portion of the external environment. In some embodiments, the at least one display is positioned at the least one portion of the vehicle that is the visual obstruction of the portion of the external environment, and wherein the at least one display conforms to a shape of the visual obstruction. In some embodiments, the at least one perception sensor may include at least one of a camera, a radar detector, a light detection and ranging (Lidar) camera, or an ultrasonic camera.

In another illustrative embodiment, the present disclosure provides an assembly for a vehicle. The assembly includes: at least one portion of the vehicle that is a visual obstruction of a portion of an external environment from a perspective of an interior position in the vehicle; at least one perception sensor, wherein the at least one perception sensor captures images of the external environment; and a plurality of displays positioned inside the vehicle, wherein the plurality of displays present transparent views that represent portions of the external environment that are obstructed from the perspective of the interior position in the vehicle, and wherein the displays of the plurality of displays are positioned at a dashboard of the vehicle and at one or more portions of the vehicle that are visual obstructions of portions of the external environment. Optionally, the at least one portion of the vehicle is one or more of an A-pillar, a B-pillar, a C-pillar, and a D-pillar of the vehicle. In some embodiments, the at least one portion of the vehicle is a roof of the vehicle. In some embodiments, the perspective of the interior position in the vehicle is a perspective of a driver's seat. In some embodiments, the at least one perception sensor has a field of view that is greater than the transparent view that is presented in the at least one display. In some embodiments, the at least one display of the plurality of displays conforms to a shape of at least one visual obstruction of the visual obstructions. In some embodiments, the at least one perception sensor may include at least one of a camera, a radar detector, a light detection and ranging (Lidar) camera, or an ultrasonic camera.

In a further illustrative embodiment, the present disclosure provides a method for providing a transparent view of an exterior of a vehicle from inside the vehicle. The method includes: capturing images of an external environment using at least one perception sensor; and presenting a transparent view using at least one display positioned inside the vehicle, wherein the transparent view represents a portion of the external environment that is obstructed by at least one portion of the vehicle from a perspective of an interior position in the vehicle. Optionally, the at least one portion of the vehicle is one or more of an A-pillar, a B-pillar, a C-pillar, and a D-pillar of the vehicle. In some embodiments, the at least one portion of the vehicle is a roof of the vehicle. In some embodiments, the perspective of the interior position in the vehicle is a perspective of a driver's seat.

### BRIEF DESCRIPTION OF THE DRAWINGS

The present disclosure is illustrated and described with reference to the various drawings, in which like reference numbers are used to denote like assembly or system components and/or method steps, as appropriate.

FIG. 1 is a block diagram of an example environment showing a view from the interior of a vehicle of a portion of the external environment.

FIG. 2 is a flow chart for providing a transparent view of an external environment from inside a vehicle.

FIG. 3 is a top-view block diagram of an example environment showing a vehicle in an external environment, where the vehicle includes a perception sensor at a B-pillar.

FIG. 4 is a top-view block diagram of an example environment showing a vehicle in an external environment, where the vehicle includes a fisheye perception sensor.

FIG. 5 is a top-view block diagram of an example environment showing a vehicle in an external environment, where the vehicle has multiple displays positioned throughout the inside of the vehicle.

FIG. 6 is a block diagram of an environment, showing a perspective toward the front of a vehicle.

FIG. 7 is a block diagram of an example computing system of the present disclosure.

### DETAILED DESCRIPTION

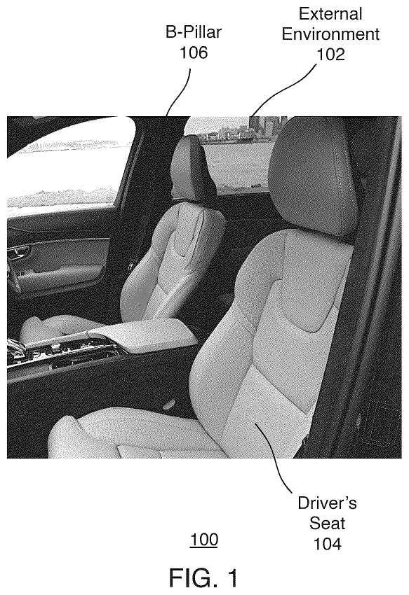

FIG. 1 is a block diagram of an example environment 100 showing a view from the interior of a vehicle of a portion of the external environment 102. As shown, the view of the external environment 102 is shown from the general perspective of the driver's seat 104. Also, the view of the external environment 102 is visible through the side windows of the vehicle, but is visibly obstructed by a B-pillar 106 of the vehicle.

As described in more detail herein, embodiments provide a seamless view or seemingly transparent view of the external environment from inside a vehicle. In various embodiments, one or more perception sensors capture portions of the external environment including areas visually obstructed from inside the vehicle. One or more displays inside the vehicle display obstructed portions of the exterior to create a seamless view in the exterior. Such displays may be positioned at the dashboard and/or at one or more of portions of the vehicle that are visual obstructions to the exterior view.

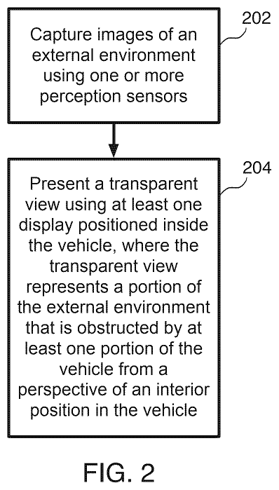

FIG. 2 is a flow chart for providing a transparent view of an external environment from inside a vehicle. Referring to FIGS. 2 through 5, a method is initiated at block 202, where a system captures images of an external environment using one or more perception sensors. In some embodiments, one or more of the perception sensors may be positioned at an exterior portion of the vehicle. In some embodiments, one or more of the perception sensors may be positioned at an interior portion of the vehicle. For example, one or more of the perception sensors may be positioned inside with view through a window (e.g., behind the front windshield, near the rear-view mirror, etc.).

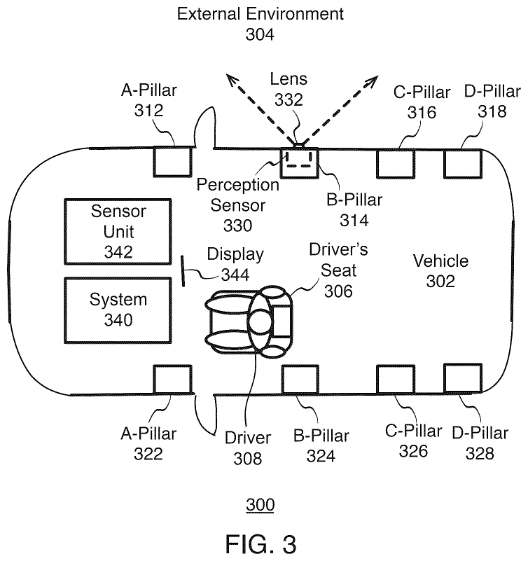

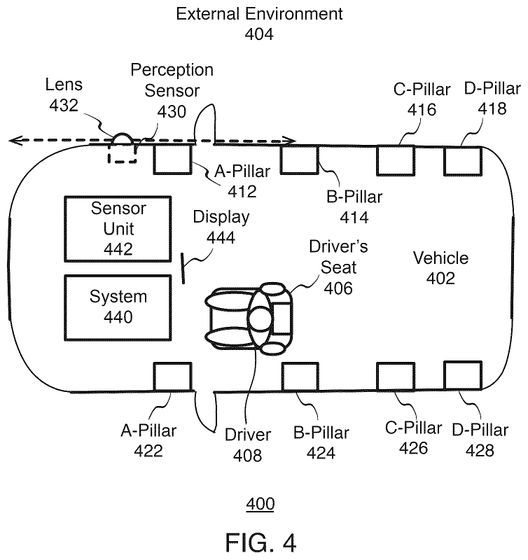

Example embodiments directed to the capturing images of the external environment are described in more detail below in connection with FIGS. 3 and 4.

At block 204, the system presents a transparent view using one or more displays positioned inside the vehicle. In various embodiments, the transparent view represents a portion of the external environment that is obstructed by at least one portion of the vehicle from a perspective of an interior position in the vehicle.

In various embodiments, the system provides a seamless view or seemingly transparent view of the external environment from inside the vehicle. As described in more detail herein, in various embodiments, one or more perception sensors capture portions of the external environment including areas visually obstructed from inside the vehicle. One or more displays inside the vehicle display obstructed portions of the exterior to create a seamless view in the exterior. Such displays may be positioned at the dashboard and/or at one or more of portions of the vehicle that are visual obstructions to the exterior view.

When displays are positioned at the obstructions (e.g., in front of or attached to the obstructions), the driver sees the actual external environment through the windows. In various embodiments, the driver also sees, on such displays, virtual images or video of the portions of the external environment that are blocked. In various embodiments, the virtual images or video are cropped and angled such that the driver sees both the actual and virtual portions of the external environment seamlessly together. As a result, the driver sees a seamless view or seemingly transparent view of the external environment from inside a vehicle. The system provides an experience to the driver of virtual windows or a clear dome. In other words, all of the pillars become seemingly transparent as the driver looks at the pillars.

In some embodiments, the system may enable the driver to activate a transparent mode manually, where the system presents images or videos of the external environment on a display on the dashboard, or on one or more displays at one or more respective pillars. Example embodiments directed to the presentation of the transparent view are described in more detail below in connection with FIGS. 3 through 6.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 3 is a top-view block diagram of an example environment 300 showing a vehicle 302 in an external environment 304, where the vehicle 302 includes a perception sensor at a B-pillar. Shown is a driver's seat 306 in which a driver 308 sits. Also shown are an A-pillar 312, a B-pillar 314, a C-pillar 316, and a D-pillar 318. These pillars are positioned on the right side of the vehicle 302. The vehicle 302 also has an A-pillar 322, a B-pillar 324, a C-pillar 326, and a D-pillar 328 positioned on the left side of the vehicle 302. Also shown is a perception sensor 330 with a lens 332, a system 340, a sensor unit 342, and a display 344. While embodiments are described herein in the context of a perception sensors such as a video perception sensors or fisheye perception sensors (FIG. 4), embodiments may also include light detection and ranging (Lidar) perception sensors and/or other types of perception sensors or cameras. Any sensing methodology may be used, and the particular sensing methodology will depend on the particular implementation. For example, in various embodiments, perception sensors may include one or more image sensing perception sensors or cameras, radar detectors, Lidar cameras, and/or ultrasonic cameras, or any combination thereof.

The A-pillars 312 and 322 are positioned between the windshield (not shown) and the left-and right-side windows (not shown) at the respective driver and front passenger areas. The B-pillars 314 and 324 are positioned between the left-and right-side windows at the respective driver and passenger areas and the left-and right-side windows (not shown) at the respective rear passenger areas. The C-pillars 316 and 326 are positioned between the left-and right-side windows at the respective rear passenger areas and the left-and right-side windows (not shown) at the back cargo area of the vehicle 302. The D-pillars 318 and 328 are positioned between the left-and right-side windows at the back cargo area and the rear window (not shown) of the vehicle 302.

Generally, larger vehicles such as wagons and sport utility vehicles (SUVs) are longer and have D-pillars. Smaller vehicles such as sedans are shorter and do not have D-pillars. As such, the C-pillars of some smaller vehicles are positioned between the left-and right-side windows at the respective rear passenger areas and the rear window of such vehicles.

The A-, B-, C-, and D-pillars 312-328 of the vehicle 302 are portions of the vehicle 302 that are visual obstructions of portions of the external environment 304 from perspectives of interior positions in the vehicle. In various embodiments described herein, the example perspective is described from the perspective of the driver's seat 306, which may also be described as the perspective of the driver 308.

In various embodiments, one or more perception sensors may be positioned at the exterior portion of the vehicle 302. Being positioned at the exterior portion of the vehicle 302 means that at least one portion of the perception sensors (e.g., the lenses) are exposed to the external environment. As indicated herein, in some embodiments, one or more perception sensors may be positioned at an interior portion of the vehicle 302 (e.g., inside with view through a window, etc.). As such, the perception sensors capture images of the external environment 304. Such images may be a continuous series of images, which may include video.

For ease of illustration, one perception sensor 330 is shown, and the perception sensor 330 shown is positioned in the B-pillar 314. There may be multiple perception sensors, where different perception sensors are positioned in each of the different pillars shown, for example. Also, such perception sensors may be positioned separately from pillars. In some embodiments, some camaras may be positioned in pillars and some may be positioned separately from pillars. For example, perception sensors may be positioned on the left-, right-, front-, and rear-sides of the vehicle 302, as well as the roof (not shown) of the vehicle 302. As such, in various embodiments, the perception sensors of the vehicle 302 capture 360-degree views of the external environment 304, including the sky.

The type of perception sensor(s) may vary, depending on the particular implementation. For example, one or more given perception sensors may be standard perception sensors or cameras having a standard field of views. One or more given perception sensors may be fisheye perception sensors or cameras having an ultra-wide field of view. An example embodiment involving a fisheye perception sensor that is positioned separately from a pillar is shown and described herein in connection with FIG. 4. One or more given perception sensors may be Lidar perception sensors or cameras, etc.

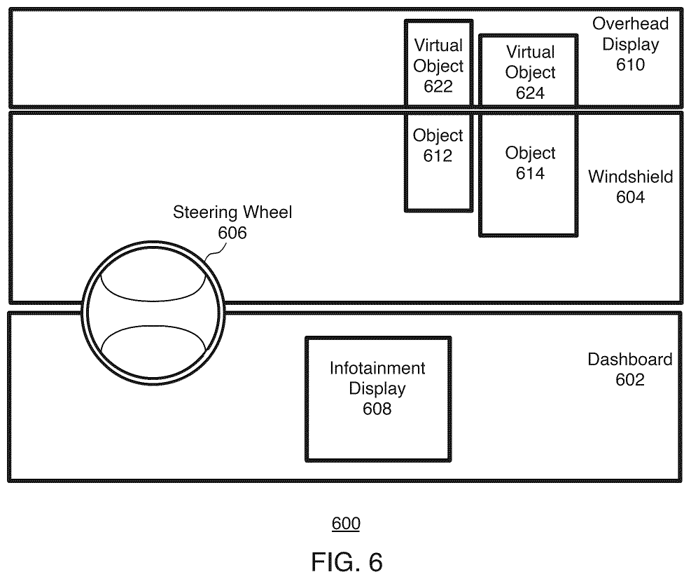

In various embodiments, the system 340 controls the perception sensor 330 as well as other perception sensors (not shown), and causes image and/or video footage to be collected and processed at the sensor unit 342. The system causes one or more displays such as display 344 positioned inside the vehicle to present a transparent view of the external environment 304. As shown, the display presents a transparent view of the external environment 304 from its position at the dashboard (FIG. 6) of the vehicle 302. As described in more detail herein, one or more displays may be positioned at various visual obstructions (e.g., in front of or attached to pillars, etc.) to provide different transparent views of the external environment. The transparent views represent one or more portions of the external environment 304 that are obstructed from the perspective of the interior position in the vehicle 302 (e.g., from the perspective of the driver). Various example embodiments of the system providing the transparent view are described in more detail herein.

The perception sensors may be referred to as client devices, which may communicate with the system 340 and/or sensor unit 342 directly or via system 340. Such communication may be facilitated via any suitable communication network (not shown) such as a wired network, a Bluetooth network, a Wi-Fi network, etc., or any combination thereof.

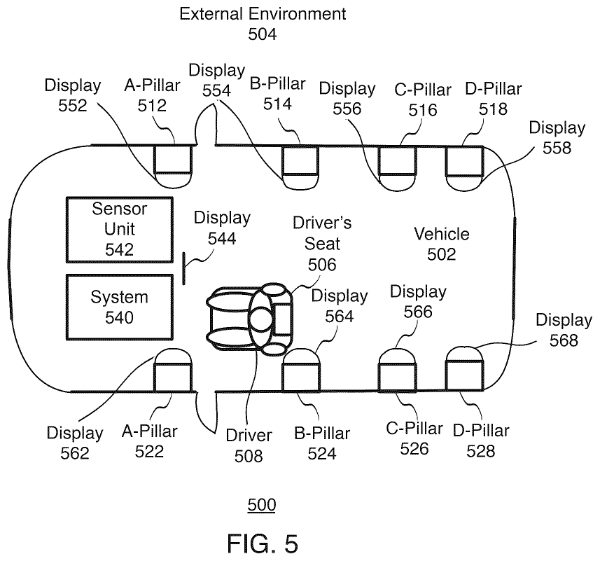

For ease of illustration, FIG. 3 shows one block for each of the perception sensor 330 system 340, sensor unit 342, display 344. Blocks 330, 340, 343, and 344 may represent multiple perception sensors, systems, sensor units, and displays. Also, there may be any number of perception sensors. In other implementations, environment 300 may not have all of the components shown and/or may have other elements including other types of elements instead of, or in addition to, those shown herein. For example, the embodiment shown in FIG. 3 may include elements not shown in FIG. 3 but shown in FIG. 4 and/or FIG. 5, for example, and vice versa.

While system 340 performs implementations described herein, in other implementations, any suitable component or combination of components associated with system 340 or any suitable processor or processors associated with system 340 may facilitate performing the implementations described herein.

FIG. 4 is a top-view block diagram of an example environment 400 showing a vehicle 402 in an external environment 404, where the vehicle 402 includes a fisheye perception sensor. Similar to the example embodiment of FIG. 3, the example embodiment of FIG. 4 includes a driver's seat 406 in which a driver 408 sits. Also shown are an A-pillar 412, a B-pillar 414, a C-pillar 416, and a D-pillar 418. These pillars are positioned on the right side of the vehicle 402. The vehicle 402 also has an A-pillar 422, a B-pillar 424, a C-pillar 426, and a D-pillar 428 positioned on the left side of the vehicle 402. Also shown is a system 440, a sensor unit 442, and a display 444.

The example embodiment shown in FIG. 4 includes a fisheye perception sensor 430 with an ultra-wide-angle lens 432. In various embodiments, the fisheye perception sensor 430 has a semispherical shaped lens and sensor to enable an ultra-wide field of view. This enables the fisheye perception sensor 430 to capture more footage of the external environment 404 from a single perception sensor (e.g., 360 degrees vertical, horizontal and 180 degrees diagonal). The actual field of view coverage may vary and will depend on the particular implementation.

For ease of illustration, FIG. 4 shows one perception sensor. As indicated above, there may be multiple perception sensors, where some perception sensors may be positioned in pillars, some perception sensors may be positioned separately from pillars, or any combination thereof. Perception sensors may be positioned on the left-, right-, front-, and rear-sides of the vehicle 402, as well as the roof (not shown) of the vehicle 402.

In various embodiments, the system 440 may divide the entire footage of the external environment 404 into subsections (e.g., slices). The system may use software such as artificial intelligence to represent the external environment 404 from different angles and different fields of view. The system may then selectively present footage that represents particular portions of the external environment from the perspective of the interior position in the vehicle and from different pillars. For example, the perception sensor 430 may capture all of the external environment 404 on the right side of the vehicle 402. The system 440 may parse the footage of the external environment 404 to show footage specifically behind the B-pillar 414 from the perspective of the driver 408 sitting in the driver's seat 406. The system may present such selected footage for each of the pillars in the vehicle 402. As described in more detail below in connection with FIG. 5, there may be multiple displays inside the vehicle 402, where each display shows the external environment 404 from different angles.

FIG. 5 is a top-view block diagram of an example environment 500 showing a vehicle 502 in an external environment 504, where the vehicle 502 has multiple displays positioned throughout the inside of the vehicle 502. Similar to the example embodiments of FIGS. 3 and 4, the example embodiment of FIG. 5 includes a driver's seat 506 in which a driver 508 sits. Also shown are an A-pillar 512, a B-pillar 514, a C-pillar 516, and a D-pillar 518. These pillars are positioned on the right side of the vehicle 502. The vehicle 502 also has an A-pillar 522, a B-pillar 524, a C-pillar 526, and a D-pillar 528 positioned on the left side of the vehicle 502. Also shown is a system 540, a sensor unit 542, and a display 544.

Shown are multiple displays including displays 544, 552, 554, 556, 558, 562, 564, 566, and 568 positioned at the dashboard and at pillars of the vehicle. For example, display 544 is positioned on the dashboard (not shown). Display 552 is positioned at A-pillar 512. Display 554 is positioned at B-pillar 514. Display 556 is positioned at C-pillar 516. Display 558 is positioned at D-pillar 518. Display 562 is positioned at A-pillar 522. Display 564 is positioned at B-pillar 524. Display 566 is positioned at C-pillar 526. Display 568 is positioned at D-pillar 528.

As indicated above, the portions of the vehicle 502 that obstruct the external environment include A-pillars 512 and 522, B-pillars 514 and 524, C-pillars 516 and 526, and D-pillars 518 and 528 of the vehicle 502. Another portion of the vehicle that obstructs the external environment includes the roof (not shown) of the vehicle 502. Various embodiments are described herein in a context of obstructed views from the perspective of a driver's seat. The perspective of the driver's seat is a significant perspective of the interior position in the vehicle that is visually obstructed from the external environment, because the driver needs to be constantly aware of the external environment 504 while driving for safety reasons. In some embodiments, the system may alert the driver if there is an object in the external environment that could cause harm or that can physically make contact with the vehicle (e.g., a person, an animal, etc.). Embodiments may also be beneficial when applied to utility vans or other cargo vehicles with very few windows, etc.

For ease of illustration, no camaras are shown in FIG. 5. As indicated above, there may be multiple perception sensors, where some perception sensors may be positioned in pillars, some perception sensors may be positioned separately from pillars, or any combination thereof. One or more perception sensors may be fisheye perception sensors such as fisheye perception sensor 430. Perception sensors may be positioned on the left-, right-, front-, and rear-sides of the vehicle 302, as well as the roof (not shown) of the vehicle 502.

The system causes the displays 544, 552, 554, 556, 558, 562, 564, 566, and 568 to present transparent views of the external environment 304. As indicated above, the transparent view at each display represents a portions of the external environment 304 that is obstructed from the perspective of an interior position in the vehicle 302, such as the position of driver's seat 506, which is also the position of the driver 508.

In various embodiments, each of the perception sensors has a field of view that is greater than the transparent view that is presented in one or more of the displays. In various embodiments, the system uses software such as artificial intelligence (AI) software to crop and modify the angle or line of sight of portions of footage of the external environment presented at each display to represent what the driver would see if the respective pillars behind the displays were not there.

The system 540 utilizes the displays 544-568 at the pillars to present transparent views of the external environment 504, where the displays are positioned at portions of the vehicle (e.g., respective pillars) that are visual obstructions of portions of the external environment. In other words, such transparent views represent the portions of the external environment 504 that are visually obstructed from the perspective of the driver 508 at that interior position in the vehicle 502.

Enabling the driver 508 to view the surrounding external environment via the displays 544 and 552-568 provides the driver 508 with significantly enhanced visibility of the surrounding external environment 504. This increases the safety for the driver 508 and passengers if any, as the driver 508 drives the vehicle 502. This also increases the joy of driving for the driver 508, as the driver 508 can better view and appreciate the surrounding external environment 504.

In various embodiments, the displays conform to the shapes of their respective visual obstruction (e.g., their respective pillars) at which the displays are positioned. For example, the displays may include flexible screens positioned on their respective pillars, thereby making the pillars appear to be transparent. By conforming to the shapes of their respective pillars, the displays provide a more effective illusion or perception to the driver 508 that the pillars are not there. The driver 508 does not see the pillars and instead sees the images or video of the portion of the external environment 504 behind the pillars. This effectively makes the side windows appear to be wrap-around continuous windows framing an unbroken view out the side of the vehicle. The displays may be in front of or attached to their respective pillars.

In various embodiments, when the driver is making a turn, the system may automatically activate perception sensors. The system may stitch together images or video from different perception sensors to display what is behind the pillars. The displays present the portions of the external environment that the driver would see as if there were no obstruction (e.g., no pillars, etc.). In various embodiments, the system may utilize displays with flexible screens over the pillars in combination with AI such that the pillars become virtually transparent during turns. For example, the system may use AI to modify the images or video of portions of the external environment based on the perspective or eye angle/line of sight of the driver. In other words, the display presents what the driver would see based on the seated position of the driver. As the vehicle moves through the external environment, the perception sensors capture footage of the external environment accordingly. The system may then crop and adjust the captured footage to the portions visible through the windows. As a result, the driver sees a seamless view of the external environment, where the seamless view is a combination of obstructed portions of the external environment virtually seen at the displays and actual portions of the external environment seen through the windows. In various embodiments, the system may also adjust the line of sight of the displayed external environment based on the height of the driver's head and the speed and/or turning direction of the vehicle.

FIG. 6 is a block diagram of an environment 600, showing a perspective toward the front of a vehicle. Shown is a dashboard 602, a windshield 604, a steering wheel 606, an infotainment display 608, and an overhead display 610. Similar to a pillar visually obstructing a portion of the external environment, the roof of the vehicle also visually obstructs a portion of the external environment. FIG. 6 is an example of a display, here the overhead display 610, being positioned on the obstruction (e.g., the roof) and presenting a transparent view that represents the portion of the external environment that is visually obstructed. As shown, objects 612 and 614 may be partially viewed through the windshield 604. The objects 612 and 614 may represent buildings or any other objects in the external environment (e.g., mountains, trees, etc.).

As shown, the top portions of objects 612 and 614 are obstructed from view due to the roof. The overhead display 610, however, presents virtual objects 622 and 624 that correspond to the top portions of objects 612 and 614. This gives the illusion or perception to the driver that the roof is not present to block the view. The size of the overhead display 610 may vary depending on the particular implementation. For example, in some embodiments, the overhead display 610 may span the entire roof such that the driver and passengers can see the sky, or specifically images or a video of the sky via overhead display 610. As a result, the driver sees a seamless view of the external environment, where the seamless view is a combination of obstructed portion of the external environment virtually seen at the display 610 and actual portions of the external environment seen through the windshield 604. In various embodiments, the system may also adjust the line of sight of the displayed external environment based on the height of the driver's head and the speed and/or turning direction of the vehicle. This example embodiment involving the display 610 presenting seamless view of the external environment is analogous to other embodiments described herein, where the displays 552-568 present seamless views of the external environment.

Embodiments described herein have numerous benefits. For example, embodiments increase the safety for a driver and passengers by eliminating typical blind spots by enabling the driver to better see the surroundings of the exterior of the vehicle as the driver drives the vehicle. Embodiments also increase the joy of driving for the driver, as the driver can better view and appreciate the surrounding external environment. Embodiments may also be applied to delivery vans or other cargo vehicles with no rear window or otherwise poor visibility.

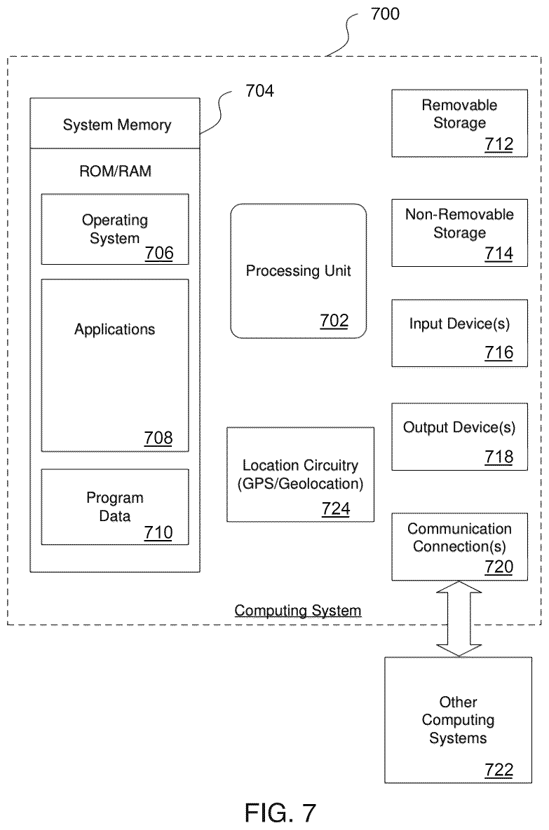

FIG. 7 is a block diagram of an example computing system 700 of the present disclosure. The computing system 700 may be used to implement the systems 340, 440, and 540 of FIGS. 3, 4, and 5, as well as to perform implementations described herein.

The computing system 700 typically includes at least one processing unit 702 and a system memory 704. Depending on the particular configuration and type of computing device, the system memory 704 may be volatile such as random-access memory (RAM), non-volatile such as read-only memory (ROM), flash memory, and the like, or some combination of volatile memory and non-volatile memory. The system memory 704 typically maintains an operating system 706, one or more applications 708, and program data 710. The operating system 706 may include any number of operating systems executable on desktops or portable devices including, but not limited to, Linux, Microsoft Windows®, Apple OS®, or Android®.

The computing system 700 may also have additional features or functionality. For example, the computing system 700 may also include additional data storage devices (removable and/or non-removable) such as, for example, magnetic disks, optical disks, tape, or flash memory. Such additional storage may include removable storage 712 and non-removable storage 714. Computer storage media may include volatile and non-volatile, removable and non-removable media implemented in any method or technology for storage of information, such as computer-readable instructions, data structures, program modules or other data. The system memory 704, the removable storage 712, and the non-removable storage 714 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 700. Any such computer storage media may be part of the computing system 700.

The computing system 700 may also have input device(s) 716 such as a keyboard, mouse, pen, voice input device, touchscreen input device, etc. Output device(s) 718 such as a display, speakers, printer, short-range transceivers such as a Bluetooth transceiver, etc., may also be included. The computing system 700 also may include one or more communication connections 720 that allow the computing system 700 to communicate with other computing systems 722, such as over a wired or wireless network or via Bluetooth (a Bluetooth transceiver may be regarded as an input/output device and a communications connection). The one or more communication connections 720 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 700 may also include location circuitry 724. In various embodiments, the location circuitry 724 may include circuitry including global positioning system (“GPS”) circuitry and/or geolocation circuitry. The location circuitry 724 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 724, including GPS circuitry and/or geolocation circuitry, is frequently incorporated in smartphones and many other tablets or other portable devices. In various embodiments, computing system 700 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiment and examples are within the spirit and scope of the present disclosure and are intended to be covered by the following non-limiting claims for all purposes.

What is claimed is:

1. An assembly for a vehicle, the assembly comprising:
at least one portion of the vehicle that is a visual obstruction of a portion of an external environment from a perspective of an interior position in the vehicle;
at least one perception sensor, wherein the at least one perception sensor captures images of the external environment; and
at least one display positioned inside the vehicle, wherein the display presents a transparent view that represents the portion of the external environment that is obstructed from the perspective of the interior position in the vehicle.

2. The assembly of claim 1, wherein the at least one portion of the vehicle is one or more of an A-pillar, a B-pillar, a C-pillar, and a D-pillar of the vehicle.

3. The assembly of claim 1, wherein the at least one portion of the vehicle is a roof of the vehicle.

4. The assembly of claim 1, wherein the perspective of the interior position in the vehicle is a perspective of a driver's seat.

5. The assembly of claim 1, wherein the at least one perception sensor has a field of view that is greater than the transparent view that is presented in the at least one display.

6. The assembly of claim 1, wherein the at least one display is positioned at a dashboard of the vehicle.

7. The assembly of claim 1, wherein the at least one display is positioned at the least one portion of the vehicle that is the visual obstruction of the portion of the external environment.

8. The assembly of claim 1, wherein the at least one display is positioned at the least one portion of the vehicle that is the visual obstruction of the portion of the external environment, and wherein the at least one display conforms to a shape of the visual obstruction.

9. The assembly of claim 1, wherein the at least one perception sensor may comprise at least one of a camera, a radar detector, a light detection and ranging (Lidar) camera, or an ultrasonic camera.

10. An assembly for a vehicle, the assembly comprising:
at least one portion of the vehicle that is a visual obstruction of a portion of an external environment from a perspective of an interior position in the vehicle;
at least one perception sensor, wherein the at least one perception sensor captures images of the external environment; and
a plurality of displays positioned inside the vehicle, wherein the plurality of displays present transparent views that represent portions of the external environment that are obstructed from the perspective of the interior position in the vehicle, and wherein the displays of the plurality of displays are positioned at a dashboard of the vehicle and at one or more portions of the vehicle that are visual obstructions of portions of the external environment.

11. The assembly of claim 10, wherein the at least one portion of the vehicle is one or more of an A-pillar, a B-pillar, a C-pillar, and a D-pillar of the vehicle.

12. The assembly of claim 10, wherein the at least one portion of the vehicle is a roof of the vehicle.

13. The assembly of claim 10, wherein the perspective of the interior position in the vehicle is a perspective of a driver's seat.

14. The assembly of claim 10, wherein the at least one perception sensor has a field of view that is greater than the transparent view that is presented in the at least one display.

15. The assembly of claim 10, wherein at least one display of the plurality of displays conforms to a shape of at least one visual obstruction of the visual obstructions.

16. The assembly of claim 10, wherein the at least one perception sensor may comprise at least one of a camera, a radar detector, a light detection and ranging (Lidar) camera, or an ultrasonic camera.

17. A method for providing a transparent view of an exterior of a vehicle from inside the vehicle, the method comprising:
capturing images of an external environment using at least one perception sensor; and
presenting a transparent view using at least one display positioned inside the vehicle, wherein the transparent view represents a portion of the external environment that is obstructed by at least one portion of the vehicle from a perspective of an interior position in the vehicle.

18. The method of claim 17, wherein the at least one portion of the vehicle is one or more of an A-pillar, a B-pillar, a C-pillar, and a D-pillar of the vehicle.

19. The method of claim 17, wherein the at least one portion of the vehicle is a roof of the vehicle.

20. The method of claim 17, wherein the perspective of the interior position in the vehicle is a perspective of a driver's seat.
